(19) United States
(12) Patent Application Publication
(10) Pub. No.: US 2017/0290313 A1
(43) Pub. Date: Oct. 12, 2017

(54) FISHING ROD AND METHOD OF MANUFACTURING THE SAME

(71) Applicant: Diamondback Rod Co., LLC, Syracuse, NY (US)

(72) Inventor: Nathan Robert Dablock, East Syracuse, NY (US)

(21) Appl. No.: 15/096,954

(22) Filed: Apr. 12, 2016

(51) Int. Cl. A01K 87/08; A01K 87/06; B25G 1/10

(52) U.S. Cl. CPC A01K 87/08; B25G 1/102; A01K 87/06

(57) ABSTRACT

A fishing rod is provided. The fish rod includes a rod blank comprised of an elongated elastic member and having a first end, a reel seat extended in a first direction from the first end, and a handle having a plurality of grip members. Each of the plurality of grip members is separately disposed from one another around the first end of the rod blank.

### FIELD OF THE INVENTION

The present disclosure relates generally to a fishing rod, and more particularly to a handle of the fishing rod.

### BACKGROUND

A conventional fly fishing rod can include a rod blank, a reel and a fly. The rod blank is conventionally made in an elongated shape with flexible materials. A reel is added to the rod blank, and a line and a leader are fed from the reel through line guides on the rod blank. A fly is tied to the end of the leader and the angler is then ready to fish. The fly fishing rod in general and in particular is used in various settings in pursuit of a variety of fish. In fly fishing, the angler often uses a small light dry fly or wet fly to catch fish. These flies are too light to be cast by themselves. Rather, the angler casts the weight of the line which carries the leader and fly to the intended destination and presents it to the fish. The fly fishing rod needs to have an appropriate strength and flexibility to allow an angler to cast the line, leader and fly combination. The fly fishing rod is designed with different characteristics to provide different feels as desired by anglers. The fly fishing rod can be used either in very small fresh water streams, in large streams, or in the ocean. The fly fishing rod can be made of high tech composite materials, carbon fibers or other high tech synthetic fibers embedded in resin matrixes. The handle of the fly fishing rod has been developed to enhance gripping of the fly fishing rod; however, conventionally, the handle of the fly fishing rod is made of a single and solid piece. The handle having the single piece fails to efficiently transfer vivid movements and sensations of the rod blank to the angler. To solve this problem, a new fishing rod with a handle is required.

### SUMMARY OF THE DISCLOSURE

According to one embodiment of the present disclosure, a fishing rod is provided. The fishing rod includes a rod blank made of an elongated elastic member and having a first end, a reel seat extended in a first direction from the first end, and a handle having a plurality of grip members, wherein each of the plurality of grip members is separately disposed from one another around and adjacent to the first end of the rod blank. The fishing rod can further include a reel for a fishing line, and the reel can be disposed on the reel seat.

One of the plurality of grip members located at a middle of the handle can have a longest length and a greatest diameter. Each of the plurality of grip members is separately disposed from one another with an exposed region of a portion of the rod blank therebetween. Each of the plurality of grip members has a tapered edge. Each of the plurality of grip members has a first grip member, a second grip member, a third grip member, a fourth grip member, and a fifth grip member in an order starting from the first end in an opposite direction of the first direction. The first grip member has a greatest diameter among others, and the third grip member has a second greatest diameter among others. Each diameter of the second grip member and the fourth grip member is smaller than that of the third grip member. A diameter of the fifth grip member is smaller than that of any of the second grip member and fourth grip member.

According to another embodiment of the present disclosure, a method of manufacturing a fishing rod is provided. The method includes providing a rod blank having an elongated elastic member and having a first end, providing a reel seat extended in a first direction from the first end, receiving cork materials, cutting the cork materials into a plurality of grip members, applying glue to a plurality of predetermined areas of the rod blank where each of the plurality of grip members is located, and locating each of the plurality of grip members onto each of the plurality of predetermined areas, respectively, wherein each of the plurality of grip members is separately disposed from one another around and adjacent to the first end of the rod blank.

One of advantages, according to the embodiment of the present disclosure, includes that the handle of the fishing rod can transfer feelings, sensations and vibrations coming from the rod blank which are not altered, muffled, and insulated to the angler's hand because the fingers of the angler are in direct contact with the rod blank.

Another advantage, according to the embodiment of the present disclosure, is that it is easy to grip the handle of the fishing rod. The handle includes a plurality of grip members, and the fingers of the angler are easily able to settle between the gaps among and between the grip members. This structure reduces the amount of pressure that the angler needs to apply with his/her fingers to hold onto the rod blank. By reducing the amount of pressure needed to properly hold onto the rod blank, it reduces the amount of fatigue that the angler will experience over an extended amount of time for casting or fishing.

### BRIEF DESCRIPTION OF THE DRAWINGS

FIG. 1 is a picture of a fishing rod according to an embodiment of the present disclosure;

FIG. 2 is a simplified schematic cross-sectional view of a rod blank, a reel seat, and a handle according to the embodiment of the present disclosure;

FIG. 3 is a perspective view of the partial rod blank, the reel seat, and the handle according to the embodiment of the present disclosure; and

FIG. 4 is a side view of the partial rod blank, the reel seat, and the handle according to the embodiment of the present disclosure; and

FIG. 5 is a flowchart depicting steps for manufacturing the fishing rod.

### DETAILED DESCRIPTION

Reference is now made to the accompanying drawings which illustrate in detail examples of embodiments of the present disclosure, wherein like reference numerals refer to like elements throughout the several views. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the disclosure. The terms “comprises” and/or “comprising” are used to specify the presence of stated elements, steps, operations, and/or components, but do not preclude the presence or addition of one or more other elements, steps, operations, and/or components. The terms “first,” “second,” and the like are be used to describe various elements, but do not limit the number of elements. Such terms are only used to distinguish one element from another.

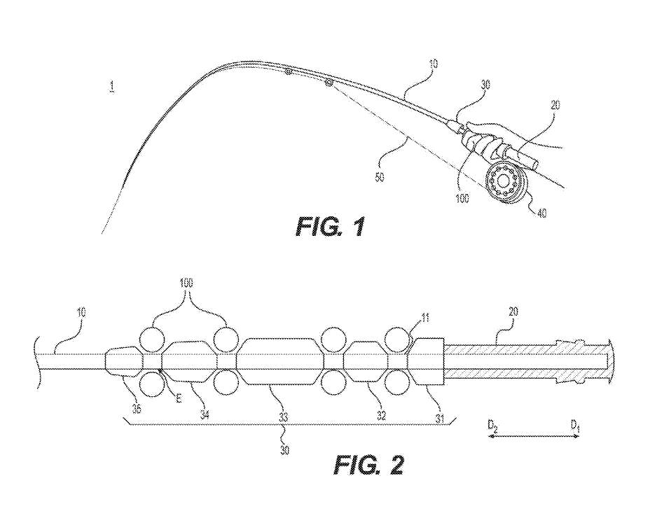

FIG. 1 is a prospective view of a fishing rod 1 according to an embodiment of the present disclosure. The fishing rod 1 includes a rod blank 10, a reel seat 20, and a handle 30.

According to another embodiment of the present disclosure, the fishing rod 1 may further include a reel 40 for a fishing line 50.

The rod blank 10 is a part of the fishing rod 1 that is used to cast the fishing line 50 through the flexing and motion of its movement. During the process of casting or moving the fishing rod 1, the rod blank 10 flexes and bends in different locations depending on the location of the rod during the casting, and the angler feels the flexing, sensations and vibrations of the rod blank 10 at the handle 30. The rod blank 10 can be made of an elongated elastic member. The rod blank 10 can be made of, for instance, fiberglass, carbon fibers, graphite fibers, high modulus, graphite carbon fibers, DAIWA carbon fiber materials, SVF carbon fibers, super SVF carbon fibers, Z-SVF carbon fibers, or bamboo. The rod blank 10 has a first end 11 at the end thereof.

The reel seat 20 is extended in a first direction D1 from the first end 11. The reel seat 20 can be made of, for instance, aluminum, which is relatively strong, light, corrosive resistant and inexpensive. Also, aluminum can be anodized with many different colors or plated with different metals, like titanium. Also, the reel seat 20 can be made with or without wooden inserts. The reel seat 20 can be detachably attached to the rod blank 10. The reel seat 20 can have a structure surrounding coaxially the rod blank 10, and be extended from the first end 11 in a first direction Dl.

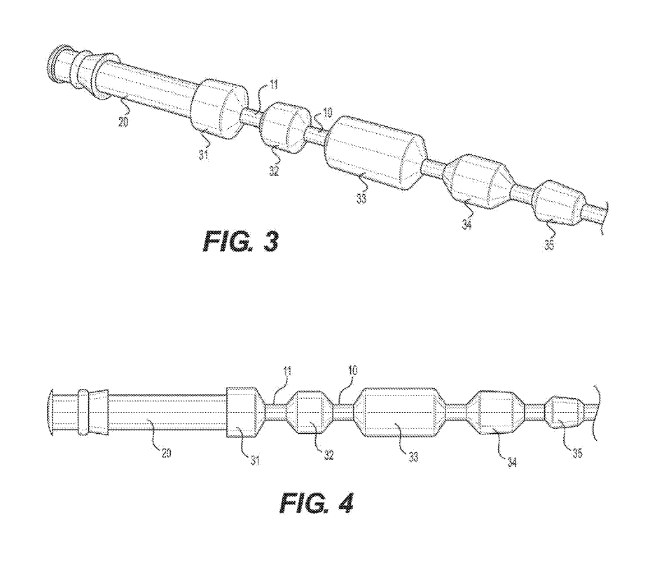

The handle 30 is where the angler is holding onto the fishing rod 1. The angler can feel the feelings, sensation, and vibrations of the rod blank 10 through the handle 30. The handle 30 is a connecting point among the rod blank 10, reel seat 20, reel 40, and fishing line 50, and where the angler can interpret what is happening with the fishing rod 1. The handle 30 can be made of, for instance, cork, plastic, wood, or cloth. The handle 30 has a plurality of grip members 31, 32, 33, 34 and 35. Each of the plurality of grip members 31, 33, and 35 is separately disposed from one another adjacent to the first end 11 of the rod blank 10. The handle 30 will be further described with reference to FIGS. 2-4 later.

The reel 40 is a cylindrical device attached to the rod blank 10 for winding and retrieving the fishing line 50. The reel 40 can be disposed and seated on the reel seat 20.

The fishing line 50 is a cord used or made for angling. The fishing line 50 can be chosen for a given fishing environment in consideration of breaking strength, knot strength, UV resistance, limpness, stretch, abrasion resistance, and visibility.

Now, with reference to FIGS. 2-4, the handle 30 would be described further. The handle 30 is segmented by a plurality of grip members 31, 32, 33, 34 and 35. As depicted in FIG. 2, each of the plurality of grip members 31, 32, 33, 34 and 35 is separately disposed from one another adjacent to the first end 11 of the rod blank 10. The handle 30 can be made of cork or plastic and be attached to the rod blank 10 by glue.

Compared to prior art which has a solid-one-piece handle, according to one embodiment of the present disclosure, the handle 30 has gaps in which the angler's fingers can be nestled. This structure can reduce the amount of pressure that the angler needs to apply with his figures to hold onto the fishing rod 1. Further, the angler's fingers can be in direct contact with the rod blank 10 so that the angler can feel the un-interrupted transmission of vibration of the rod blank 10.

One of the plurality of grip members located at a middle 33 of the handle 30 may have a longest length in the elongated direction of the rod blank 10, and a greatest diameter. Each of the plurality of grip members 31, 32, 33, 34, and 35 is separately disposed from one another with an exposed region “E” of a portion of the rod blank 10, the exposed region “E” being defined by the plurality of grip members 31, 32, 33, 34, and 35. A distance between adjacent grip members 31, 32, 33, 34, and 35 defines a gap or the size of the exposed region “E” of the portion of the rod blank 10. The reference number 100 in FIG. 2 refers to fingers of the angler. The exposed region “E” between the grip members 31, 32, 33, 34, and 35 provides a concave structure, which allows the angler to make a firm grip with ease because the fingers can be nestled on the handle 30. Furthermore, the exposed region “E” provides the angler with a direct contact with the rod blank 10. Thus, the angler can have direct feelings, sensations and vibration coming from the rod blank 10 without any barriers.

Further, each of the plurality of grip members 31, 32, 33, 34, and 35 can have a first grip member 31, a second grip member 32, a third grip member 33, a fourth grip member 34, and a fifth grip member 35 in an order starting from the first end 11 in an opposite direction D2 of the first direction D1. For the exemplary purpose only, FIG. 2 depicts that the handle 30 includes five (5) grip members 31, 32, 33, 34, and 35, but it is not limited thereto. Table 1 below shows that a diameter and a length of each of the five (5) grip members 31, 32, 33, 34, and 35.

TABLE 1

| | Diameter (cm) | Length (cm) |
|---|---|---|
| First Grip Member 31 | 2.54-2.6416 | 0.9525-1.905 |
| Second Grip Member 32 | 2.159 | 1.27-2.2225 |
| Third Grip Member 33 | 2.3622-2.4384 | 3.4925-4.445 |
| Fourth Grip Member 34 | 2.0828-2.286 | 1.5875-2.8575 |
| Fifth Grip Member 35 | 1.4986-1.7272 | 1.27-1.905 |

With reference to Table 1 above, each diameter of the second grip member 32 and the fourth grip member 34 is smaller than that of the third grip member 33. A diameter of the fifth grip member 35 is smaller than that of any of the second grip member 32 and fourth grip member 34. Further, each of the plurality of grip members 31, 32, 33, 34, and 35 has a tapered edge.

According to another embodiment of the disclosure, the first grip member 31 can have a greatest diameter among others, and the third grip member 33 can have a second greatest diameter among others.

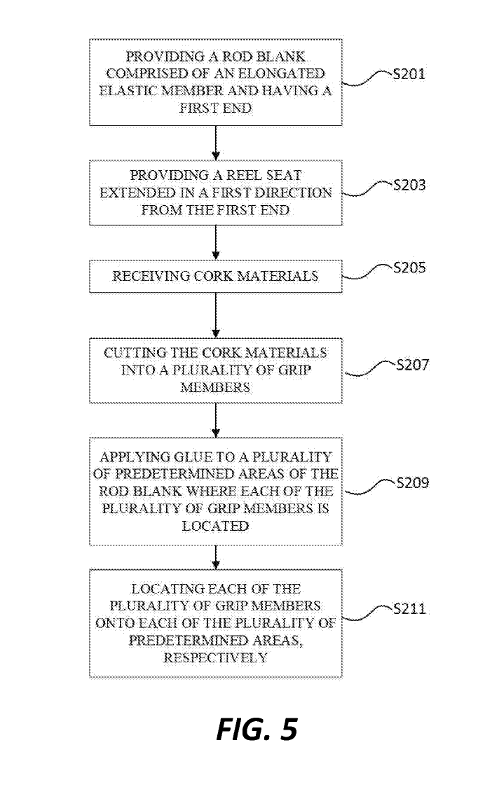

FIG. 5 is a flowchart depicting steps for manufacturing the fishing rod 1. With reference to FIG. 5, a method of manufacturing the handle 30 of the fishing rod 1 is described. The method includes providing the rod blank 10 having an elongated elastic member and having the first end 11 (S201), providing the reel seat 20 extended in the first direction D1 from the first end 11 (S203), receiving cork materials (S205), cutting the cork materials into the plurality of grip members (S207), applying glue to a plurality of predetermined areas of the rod blank 10 where each of the plurality of grip members is located (S209), and locating each of the plurality of grip members onto each of the plurality of predetermined areas, respectively, where each of the plurality of grip members is separately disposed from one another around the first end of the rod blank (S211).

It is to be understood that the exemplary embodiments described herein are that for presently preferred embodiments and thus should be considered in a descriptive sense only and not for purposes of limitation. Descriptions of features or aspects within each embodiment should typically be considered as available for other similar features or aspects in other embodiments.

What is claimed is:

1. A fishing rod comprising:
a rod blank including an elongated elastic member and a first end;
a reel seat extended in a first direction from the first end; and
a handle having a plurality of grip members, wherein each of the plurality of grip members is separately disposed from one another.

2. The fishing rod of claim 1, wherein the fishing rod further comprises a reel for a fishing line, the reel disposed on the reel seat.

3. The fishing rod of claim 1, wherein one of the plurality of grip members located at a middle of the handle has a longest length.

4. The fishing rod of claim 1, wherein one of the plurality of grip members located at a middle of the handle has a greatest diameter.

5. The fishing rod of claim 1, wherein the handle includes an exposed region of a portion of the rod blank, the exposed region being disposed between each other of the plurality of grip members.

6. The fishing rod of claim 1, wherein each of the plurality of grip members has a tapered edge.

7. The fishing rod of claim 1, wherein each of the plurality of grip members has a first grip member, a second grip member, a third grip member, a fourth grip member, and a fifth grip member disposed in an order starting from the first end in an opposite direction of the first direction.

8. The fishing rod of claim 7, wherein the first grip member has a greatest diameter, the third grip member has a second greatest diameter.

9. The fishing rod of claim 7, wherein each diameter of the second grip member and the fourth grip member is smaller than that of the third grip member.

10. The fishing rod of claim 7, wherein a diameter of the fifth grip member is smaller than that of any of the second grip member and fourth grip member.

11. A method of manufacturing a fishing rod, the method comprising:
providing a rod blank including an elongated elastic member and a first end;
providing a reel seat extended in a first direction from the first end;
receiving cork materials;
cutting the cork materials into a plurality of grip members;
applying glue to a plurality of predetermined areas of the rod blank where each of the plurality of grip members is located; and
locating each of the plurality of grip members onto each of the plurality of predetermined areas, respectively, wherein each of the plurality of grip members is separately disposed from one another adjacent to the first end of the rod blank.

12. The method of claim 11, wherein the fishing rod further comprises a reel for a fishing line, the reel disposed on the reel seat.

13. The method of claim 11, wherein one of the plurality of grip members located at a middle thereof has a longest length.

14. The method of claim 11, wherein one of the plurality of grip members located at a middle thereof has a greatest diameter.

15. The method of claim 11, wherein each of the plurality of grip members is separately disposed from one another with an exposed region of a portion of the rod blank therebetween.

16. The method of claim 11, wherein each of the plurality of grip members has a tapered edge.

17. The method of claim 11, wherein each of the plurality of grip members has a first grip member, a second grip member, a third grip member, a fourth grip member, and a fifth grip member disposed in an order starting from the first end in an opposite direction of the first direction

18. The method of claim 17, wherein the first grip member has a greatest diameter, the third grip member has a second greatest diameter.

19. The method of claim 17, wherein each diameter of the second grip member and the fourth grip member is smaller than that of the third grip member.

20. The method of claim 17, wherein a diameter of the fifth grip member is smaller than that of any of the second grip member and fourth grip member.
